(19) United States
(12) Patent Application Publication
(10) Pub. No.: US 2021/0295129 A1
(43) Pub. Date: Sep. 23, 2021

(54) RFID ELECTRONIC TAG AND PROCESSING METHOD

(71) Applicants: QINGDAO HIGHWAY IOT TECHNOLOGY CO., LTD., QINGDAO, Shandong Province (CN); MESNAC CO., LTD., QINGDAO, Shandong Province (CN)

(72) Inventors: LANFEI DONG, QINGDAO, SHANDONG PROVINCE (CN); YONG YAO, QINGDAO, SHANDONG PROVINCE (CN); HAIJUN CHEN, QINGDAO, SHANDONG PROVINCE (CN)

(21) Appl. No.: 17/259,486

(22) PCT Filed: Jul. 10, 2019
(86) PCT No.: PCT/CN2019/095394

§ 371 Date: Jan. 11, 2021

(30) Foreign Application Priority Data
Jul. 10, 2018 (CN) 201810752286.7

(51) Int. Cl. G06K 19/077; G06K 19/07

(52) U.S. Cl. CPC G06K 19/07773; G06K 19/0723; G06K 19/0772; G06K 19/07747

(57) ABSTRACT

Disclosed is an RFID electronic tag and a method for process the RFID electronic tag, the RFID electronic tag comprises a substrate, antennas and a RF module which are soldered on the substrate, wherein each end of the substrate is formed a U-shaped groove, welding pads where the antennas are soldered are respectively provided on the substrate adjacent to both sides of each U-shaped groove, the U-shaped grooves are used to clamp the antennas and the antennas are fixed on the substrate by welding. The beneficial effect of the invention is to reduce the overall thickness of the RFID electronic tag equivalent to the thickness of the diameter of the antenna and lower the risk of occurrence of bubble in package process.

The present application is based on and claims priority to Chinese patent application RFID Electronic Tag and Processing Method, No. 201810752286.7 filed on Jul. 10, 2018, the content of which are also hereby incorporated by reference in its entirety.

### FIELD OF THE INVENTION

The invention belongs to the technical field of RFID device, and particularly relates to a RFID electronic tag embedded into tire and a processing method for the RFID electronic tag.

### BACKGROUND

RFID (Radio Frequency Identification) is a technology capable of realizing automatic non-contact identification, which transmits and obtains data through radio frequency signals and automatically identifies target objects. The identification does not require manual intervention and could deal with various harsh environments. Furthermore, RFID technology could identify moving objects at high speed, and also could identify a plurality objects with tags at the same time, which is efficient and also convenient for operation. The RFID system typically comprises: a tag consisting of a coupling element and a chip, a reader which is a device configured to read or write tag information, and antenna configured to transmit radio frequency signals between the tag and the reader.

RFID electronic tag is embedded inside tire during its molding process, which is fully combined with the tire after high-temperature vulcanization and used through the complete lifecycle of the tire to record its data which is gathered for solving problems occurring in sales or in usage, such as anti-counterfeiting, selling beyond agreed areas, claims settlement and the like. RFID electronic tag is communicated with a RF module for sending or receiving data. Due to the fact that bending or deformation of the tire during usage or manufacturing may lead in the separation of the RFID electronic tag, which may be damaged, broken or worn, the optimization of the structure of the electronic tag could effectively improve the robustness of the electronic tag.

Chinese Patent Application (CN103068598A) discloses a spring oriented RFID board, in which two asymmetric arms are provided on a printed circuit board (PCB) so as to form recesses at opposite ends of the printed circuit board. Antenna elements spirally wound are positioned within the recesses so that ends of the two asymmetric arms could be positioned to form a closet path adjacent an individual antenna element spirally wound. But the antenna element spirally wound requires to be clamped into the printed circuit board the process is complicated requiring manual operation and could not be automatically produced in large quantities.

### SUMMARY OF THE INVENTION

In order to solve the above-mentioned technical problems, the present invention provides an RFID electronic tag and a method for processing the RFID electronic tag, which aims at reducing the overall thickness of the RFID electronic tag to the diameter of an antenna approximately, so that the occurrence of bubble during package could be brought down.

The technical solution of the present invention is:

An RFID electronic tag including a substrate, an RF module and antennas soldered on the substrate, wherein each end of the substrate is formed a U-shaped groove configured to arrange one of the antennas; welding pads where the antennas are soldered are respectively provided on the substrate adjacent to both sides of each U-shaped groove.

Compared with the prior art, the present invention discloses an RFID electronic tag aiming at reducing the overall thickness of the electronic tag. In the RFID electronic tag of the prior art, the antenna is attached onto the surface of the substrate so the overall thickness of the electronic tag, which is being added the thickness of solder paste, is comparatively high. As such an electronic tag being implanted into a tire, there will be a risk of the occurrence of bubble. The present invention provides two U-shaped grooves on both ends of the substrate to clamp the antennas to reduce the overall thickness of the electronic tag, so as to lower the risk of the occurrence of bubble.

Due to the fact that the faces of the electronic tag of the present invention are different, it may encounter failures as being automatically implanted in large quantities.

On the basis of the above-mentioned structure, the present invention further discloses:

the width of the U-shaped groove is greater than or equal to the width of the antenna. Preferably, the width of the U-shaped groove could be designed slightly greater than the width of the antenna because during the process of the RFID electronic tag, solder paste is firstly applied and it may flow to side walls of the U-shaped groove to enable the width of the U-shaped groove to be slightly narrowed. Accordingly, although the width of the U-shaped is slightly larger than the width of the antenna, the antenna and RF module could be soldered on the substrate without being affected.

Further, the pitch of a section of the antenna in the U-shaped groove is smaller than or equal to the pitch of a section of the antenna out of the U-shaped groove. That is to say, the pitch of the welding end of the antenna is comparatively smaller, so the welding area could be increased to enhance the robustness of antenna welding.

Another aspect of the present invention is to provide a processing method of an RFID electronic tag, which comprises:
1) applying solder paste: applying solder paste on a printed substrate;
2) placing chip: mounting on a chip by SMT equipment, namely a RF module is being directly mounted on the surface of the substrate;
3) arranging antenna: placing an antenna above a U-shaped groove and pressing the antenna down to the U-shaped groove of the substrate;
4) soldering: welding the RF module and the antennas on the substrate by wave soldering or reflow soldering.

In Step 3), an antenna is being placed at a side end of a U-shaped groove of the substrate and the antenna is being pushed into the U-shaped groove from the side end of the U-shaped groove.

The beneficial effect of the invention is to reduce the overall thickness of the RFID electronic tag equivalent to the thickness of the diameter of the antenna and lower the risk of occurrence of bubble in package process.

### BRIEF DESCRIPTION OF THE DRAWINGS

FIG. 1 is a plan view of an RFID electronic tag in accordance with one or more embodiments of the invention;

FIG. 2 is a front view of an RFID electronic tag in accordance with one or more embodiments of the invention;

FIG. 3 is a schematic structural diagram of an RFID electronic tag a prior art;

FIG. 4 is a schematic structural diagram of an RFID electronic tag before welding in accordance with one or more embodiments of the invention;

In those figures, 1: Substrate; 2: Radio frequency module; 3: Antenna; 5: Connection Area between Antenna and Radio Frequency Module; 6: U-shaped Groove.

### DETAILED DESCRIPTION

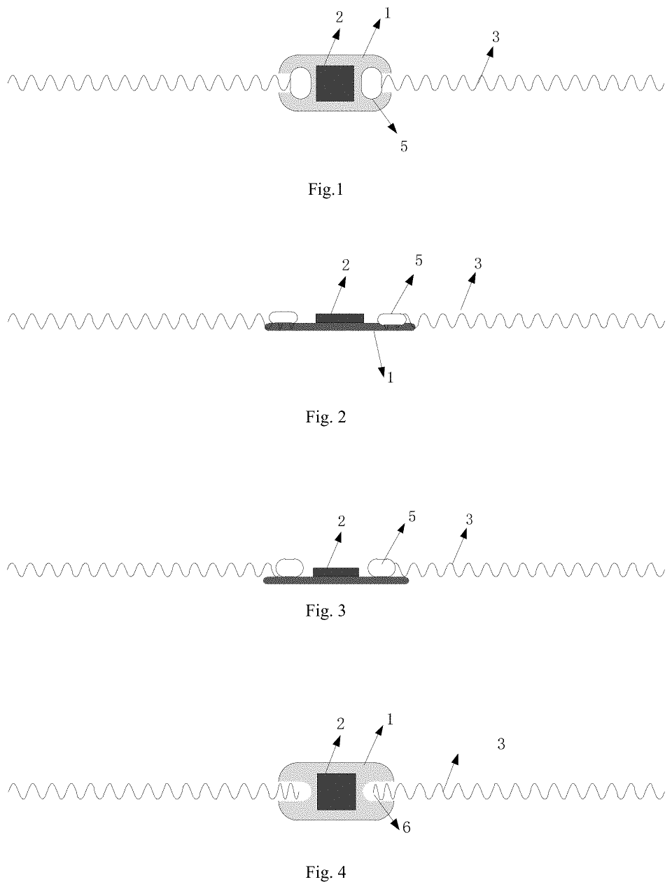

FIG. 1 is a plan view of an RFID electronic tag in accordance with one or more embodiments of the invention. The RFID electronic tag includes a substrate 1, an RF module 2 and antennas 3 soldered on the substrate 1. Each end of the substrate 1 is formed a U-shaped groove 6 configured to arrange an antenna 3. Welding pads where the antennas 3 are soldered are respectively provided on the substrate 1 adjacent to both sides of each U-shaped groove 6. The width of the U-shaped groove 6 is greater than or equal to the width of the antenna 3. The pitch of a section of each antenna in the U-shaped groove is smaller than or equal to the pitch of a section of each antenna out of the U-shaped groove, which is shown in FIG. 2 and FIG. 4.

An RFID electronic tag processing method, comprising:
1) applying solder paste: applying solder paste on a printed substrate;
2) placing chip: mounting on a chip by SMT equipment, that is to say, a RF module is being directly mounted on the surface of the substrate;
3) arranging antenna: placing one antenna above a U-shaped groove and pressing the antenna down to the U-shaped groove of the substrate;
4) soldering: welding the RF module and the antennas on the substrate by wave soldering or reflow soldering

Additionally, in Step 3), an antenna could be placed in a U-shaped groove by pushing from one side; specifically, an antenna is being placed at a side end of a U-shaped groove of the substrate and the antenna is being pushed into the U-shaped groove from the side end of the U-shaped groove.

FIG. 2 shows the connection of an RFID electronic tag of the present invention and FIG. 3 shows the connection of an RFID electronic tag of the prior art. The two figures clearly indicate that the thickness of a connection area between an antenna and an RF module of the present invention, namely the thickness after welding, is significantly smaller than the thickness of a connection area between an antenna and an RF module of the prior art, the thickness reduced is equivalent to the thickness of a substrate.

1. An RFID electronic tag including:
a substrate;
an RF module and antennas which are soldered on the substrate, wherein,
each end of the substrate is formed a U-shaped groove configured to arrange one of the antennas;
welding pads where the antennas are soldered are respectively provided on the substrate adjacent to both sides of each U-shaped groove.

2. The RFID electronic tag of claim 1, wherein the width of the U-shaped groove is greater than or equal to the width of the antenna.

3. The RFID electronic tag of claim 1, wherein the pitch of a section of the antenna in the U-shaped groove is smaller than or equal to the pitch of a section of the antenna out of the U-shaped groove.

4. An RFID electronic tag processing method, comprising:
1) applying solder paste: applying solder paste on a printed substrate;
2) placing chip: mounting on a chip by SMT equipment, namely a RF module is being directly mounted on the surface of the substrate;
3) arranging antenna: placing an antenna above a U-shaped groove and pressing the antenna down to the U-shaped groove of the substrate;
4) soldering: welding the RF module and the antennas on the substrate by wave soldering or reflow soldering.

5. The RFID electronic tag processing method of claim 4, wherein in Step 3), an antenna is being placed at a side end of a U-shaped groove of the substrate and the antenna is being pushed into the U-shaped groove from the side end of the U-shaped groove.
